(19) United States
(12) Patent Application Publication
(10) Pub. No.: US 2006/0111153 A1
(43) Pub. Date: May 25, 2006

(54) Method of alerting incoming call for wireless telephone apparatus

(76) Inventors: Chang-Chin Lai, Taipei (TW); Ya-Hsun Hsu, Taipei (TW)

Correspondence Address: HARNESS, DICKEY & PIERCE, P.L.C., P.O. BOX 8910, RESTON, VA, 20195, US

(21) Appl. No.: 10/995,420

(22) Filed: Nov. 24, 2004

(51) Int. Cl. H04B 1/00

(52) U.S. Cl. 455/567

(57) ABSTRACT

A method of alerting incoming call for wireless telephone apparatus includes the procedures of: receiving a calling signal sent from a wireless telephone apparatus by a wireless transceiver module of a computer enabled platform, confirming the phone identification data in the calling signal matching a preset comparison data, and switching a display condition of a display element of the computer enabled platform. Hence users can confirm whether an incoming call arrived the wireless telephone apparatus through the alteration of the display element to avoid missing important information.

### FIELD OF THE INVENTION

The present invention relates to a method of alerting incoming calls for wireless telephone apparatus and particularly to a method that provides alerts through a display element of an executing computer platform according to the calling condition of the wireless telephone apparatus.

### BACKGROUND OF THE INVENTION

With continuous advance of technology and dropping of manufacturing cost, wireless telephone apparatus (such as mobile phone) and executing computer platforms (such as portable computers) have become indispensable items in the life of many people. The wireless telephone apparatus has the characteristics of small size, light- weight and portability, thus has become an excellent tool for users to handle and manage information. On the other hand, the services, provided by the executing computer platforms, have taken more than half the time of the daily life of many people.

Most conventional users of wireless telephone apparatus rely on a ring tone to confirm the condition of incoming calls. But in some occasions the ring tone cannot be used to confirm the calling condition. For instance, the ring tone of the wireless telephone apparatus is set to a mute mode or the sound volume of the ring tone is restricted (such as: the user is listening music through an earphone, or the wireless telephone apparatus is located at a distance from the user). The incoming call could be missed.

Refer to FIG. 1 for a conventional method to allow users to avoid missing the incoming call. It has an executing computer platform that processes various types of application programs to couple with the wireless telephone apparatus and avoid missing incoming calls.

However, many users often forget to couple the wireless telephone apparatus with the executing computer platform. Hence missing the incoming call still happens. How to prevent such an incidence from occurring is an issue to be solved.

### SUMMARY OF THE INVENTION

In view of the foregoing problems, the object of the present invention is to provide a method of alerting incoming calls for wireless telephone apparatus. According to the method of the invention, the wireless telephone apparatus transmits a calling signal to a computer enabled platform through a wireless transceiver module (such as a Bluetooth or Infrared (IrDA) communication module) that has a selected transmission distance when receiving an incoming call, and the computer enabled platform switches a display condition of a display element to enable the user to confirm the condition of the incoming call. Hence the invention avoids missing the incoming call caused by mute setting of the wireless telephone apparatus or restricting of the sound volume of the ring tone.

To achieve the foregoing object, the method of alerting incoming calls for wireless telephone apparatus according to the invention includes the following procedures: generating a trigger signal through a user operation interface to execute a wireless transceiver module; receiving a calling signal transmitted from a wireless telephone apparatus through the wireless transceiver module, the calling signal including a phone identification data; capturing the phone identification data; verifying whether the phone identification data and a preset comparison data are matched; when matched, switching a display element on a computer enabled platform to a display condition.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a conventional measure to avoid missing incoming call information.

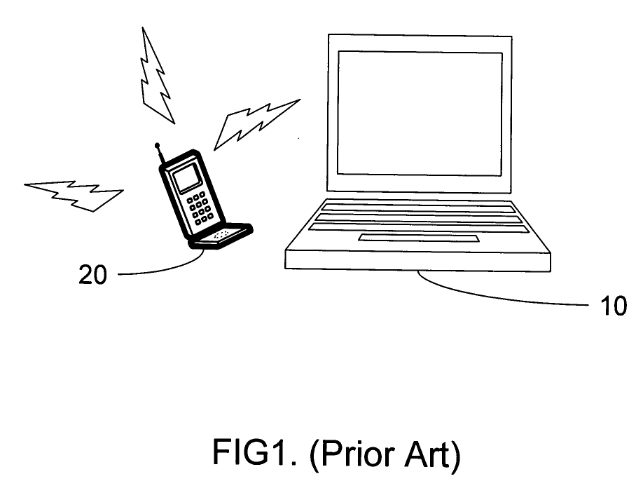

FIG. 2 is a process flow chart of an embodiment according to the method of the invention.

FIG. 3 is a setting process flow chart of the user operation interface of the invention.

FIG. 4 is a schematic view of a first embodiment of the invention.

FIG. 5 is a schematic view of a second embodiment of the invention.

FIG. 6 is a schematic view of a third embodiment of the invention.

### DESCRIPTION OF THE PREFERRED EMBODIMENTS

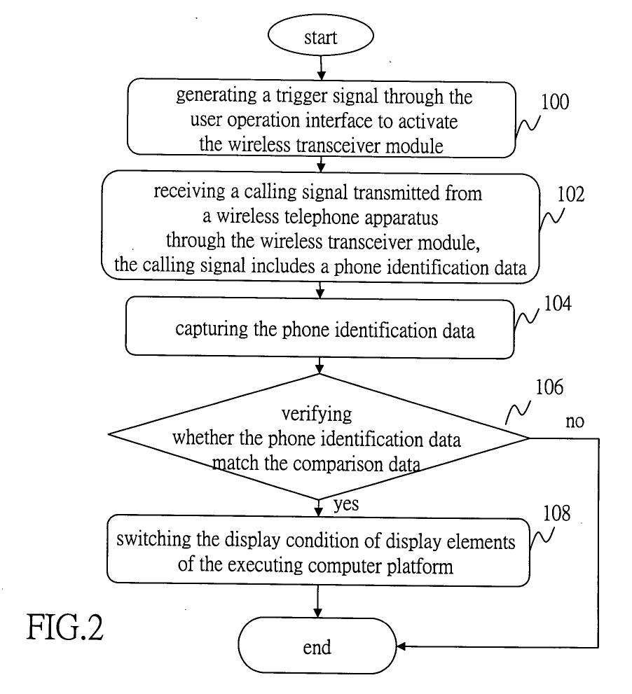

Refer to FIG. 2 for a process flow of an embodiment of the method of the invention that allows a display element 30 of an executing computer platform 10 to provide an alert when a wireless telephone apparatus 20(such as a mobile phone) has received an incoming call. Both the wireless telephone apparatus 20 and the executing computer platform 10 have a wireless transceiver module (such as a Bluetooth or Infrared (IrDA) communication module) for data transmission.

Besides the display element 30, the executing computer platform 10 also has a user operation interface and comparison data. The user operation interface provides setting fields for the comparison data, setting items of display conditions, setting selections of audio conditions and control selections for the wireless transceiver module. The setting fields for the comparison data allow users to set the comparison data, which are phone identification data of the wireless telephone apparatus 20 that the user wants have in alerted mode.

The setting items of display conditions aim to set display frequencies and display methods of the display element 30. The display element 30 may be a dot-matrix LCD display module, a Light Emitting Diode (LED), or a software display element 30. The software display element 30 is a graphic executable in the operating system made through a programming language. The setting selections of audio conditions aim to set audio signal types or sources. The audio signal may be generated concurrently with the alert of the executing computer platform 10. The control selections for the wireless transceiver module aim to generate a trigger signal to activate the wireless transceiver module of the executing computer platform 10.

Refer to FIG. 2, the method of alerting incoming calls for wireless telephone apparatus 20 according to the invention includes the following procedures: first, generating a trigger signal through the user operation interface to activate the wireless transceiver module (step 100); next, receiving a calling signal transmitted from a wireless telephone apparatus 20 through the wireless transceiver module, the calling signal includes a phone identification data (step 102); when the wireless telephone apparatus 20 receives an incoming call, the calling signal is transmitted to an executing computer platform 10 through the wireless transceiver module; capturing the phone identification data (step 104); the executing computer platform 10 retrieves the phone identification data from the calling signal through software or by hardware decoding, and the phone identification data are the phone number data of the wireless telephone apparatus 20 that receive the incoming call;

verifying whether the phone identification data match the comparison data (step 106); when matched, the wireless telephone apparatus 20 that receives the incoming call is deemed to be owned by the user; when not matched, the wireless telephone apparatus 20 that receives the incoming call is deemed not to be owned by the user;

Finally, switching the display condition of display element 30s of the executing computer platform 10 (step 108); when match of the comparison is confirmed, the executing computer platform 10 switches the display condition of the display element 30 according to the display condition setting, and also generates a corresponding audio signal according to the audio signal condition setting.

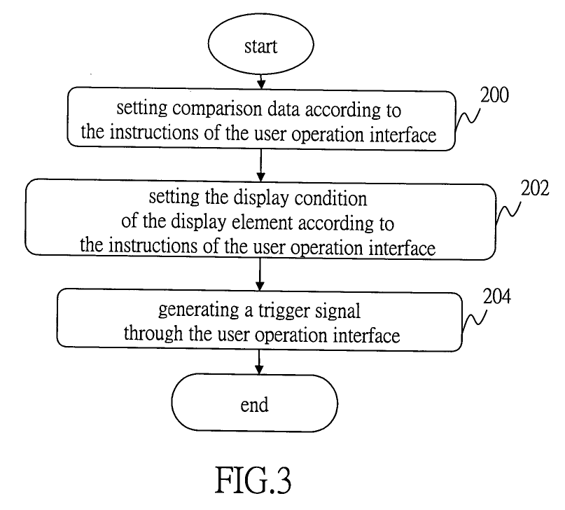

Refer to FIG. 3 for the process flow of setting the user operation interface to be performed before the executing computer platform 10 is activated to provide alert of incoming calls. It includes the following procedures: first, setting comparison data according to the instructions of the user operation interface (step 200); next, setting the display condition of the display element 30 according to the instructions of the user operation interface (step 202); finally, generating a trigger signal through the user operation interface (step 204). The trigger signal can activate the wireless transceiver module of the executing computer platform 10 to receive the calling signal transmitted from the wireless telephone apparatus 20. The user operation interface may also be used to set the audio signal condition.

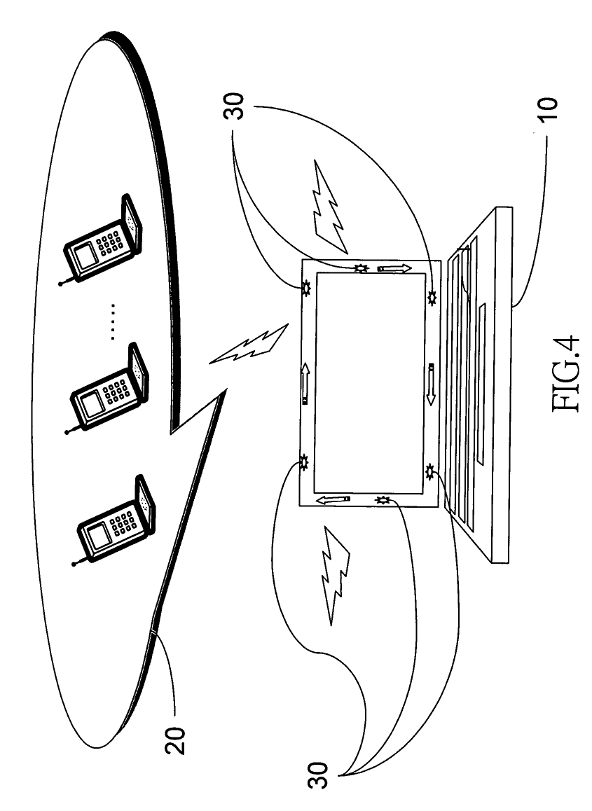

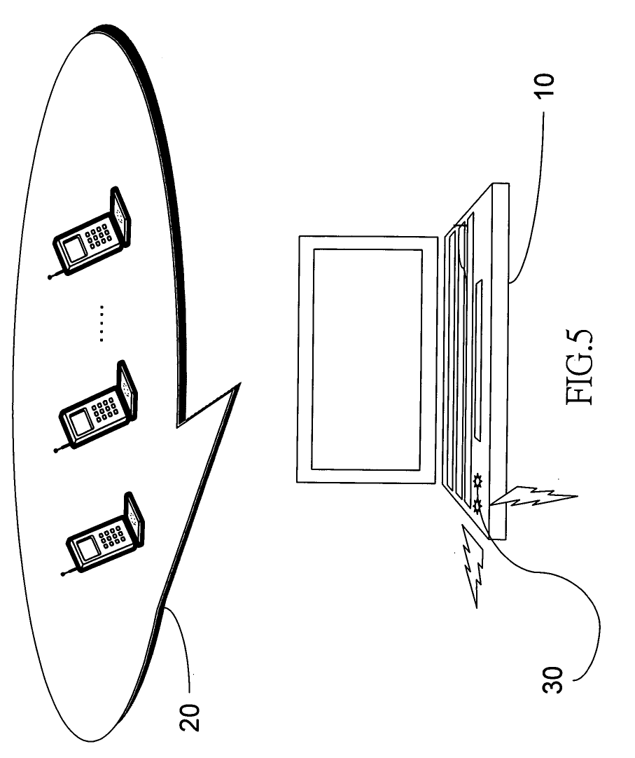

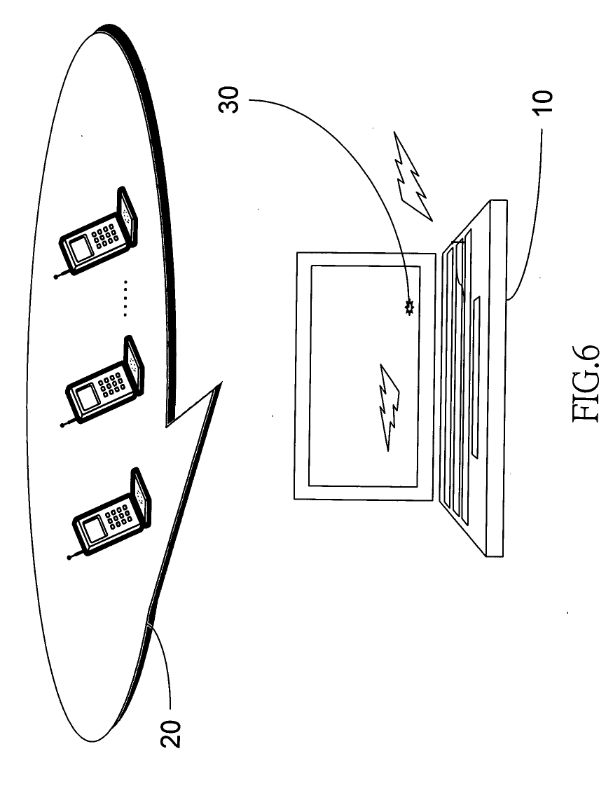

Refer to FIGS. 4, 5 and 6 for embodiments of the display element 30 adopted for use on a portable computer, which is used as the executing computer platform 10. FIG. 4 illustrates a first embodiment, FIG. 5 shows a second embodiment, and FIG. 6 shows a third embodiment.

Referring to FIG. 4, the display element 30 for alerting incoming calls is located on the back panel of a liquid crystal display (LCD) of the portable computer. FIG. 5 indicates that the display element 30 (such as the one for displaying system conditions or battery capacity) originally located on the portable computer also serves as a display element 30 to alert the user. FIG. 6 shows that a software display element 30 in the operating system is used as a display element 30 to alert the user.

By means of the method of the invention, when the computer enabled platform receives phone identification data that match the preset phone number data, the display element 30 is switched to the display condition. Hence the wireless telephone apparatus 20 of the selected phone number can get an alert through the executing computer platform 10 and receive the incoming call without missing.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments, which do not depart from the spirit and scope of the invention.

What is claimed is:

1. A method of alerting incoming call for wireless telephone apparatus to display a calling condition of a wireless telephone apparatus on a computer enabled platform which has a wireless transceiver module, a user operation interface and a comparison data, the method comprising the steps of:
generating a trigger signal through the user operation interface to enable the wireless transceiver module;
receiving a calling signal sent from the wireless telephone apparatus by the wireless transceiver module that includes a phone identification data;
capturing the phone identification data;
confirming matching of the phone identification data and the comparison data; and
switching at least one display element located on the computer enabled platform to a display condition.

2. The method of claim 1, wherein the generating a trigger signal from the user operation interface to enable the wireless transceiver module further includes the steps of:
setting the comparison data according to instructions of the user operation interface;
setting the display condition of the display element according to the instructions of the user operation interface; and
generating the trigger signal through the user operation interface.

3. The method of claim 1, wherein the user operation interface is allowed to set an audio condition.

4. The method of claim 1, wherein an audio signal is generated corresponding to the audio condition setting when the matching of the phone identification data and the comparison data has been confirmed.

5. The method of claim 1, wherein the phone identification data is a telephone number data.

6. The method of claim 1, wherein the comparison data is the telephone number data.

7. The method of claim 1, wherein the display element is a dot-matrix LCD display module.

8. The method of claim 1, wherein the display element is a light emitting diode.

9. The method of claim 1, wherein the display element is a software display element.

10. The method of claim 9, wherein the software display element displays in the operating system of the computer enabled platform.

11. The method of claim 1, wherein the wireless transceiver module is a Bluetooth communication module.

12. The method of claim 1, wherein the wireless transceiver module is an infrared communication module (IrDA).
